(19) United States
(12) Patent Application Publication
(10) Pub. No.: US 2024/0157580 A1
(43) Pub. Date: May 16, 2024

(54) Robot Gripper and Method of Using It

(71) Applicant: ABB Schweiz AG, Baden (CH)

(72) Inventors: Willem Vanderhoydonk, Halle (BE); Rudi Leroy, Huizingen (BE)

(73) Assignee: ABB Schweiz AG, Baden (CH)

(21) Appl. No.: 18/422,119

(22) Filed: Jan. 25, 2024

Related U.S. Application Data
(63) Continuation of application No. PCT/EP2021/071299, filed on Jul. 29, 2021.

(51) Int. Cl. B25J 15/02; B25J 9/16; B25J 13/08; B25J 15/00

(52) U.S. Cl. CPC B25J 15/0253; B25J 9/1612; B25J 13/085; B25J 15/0014

(57) ABSTRACT

A robot gripper comprises a palm and first and second fingers connected to said palm that have gripping surfaces facing each other for gripping an object between them and that are displaceable with respect to each other along a first axis normal to said gripping surfaces. The palm further carries at least a third finger having a support surface, wherein, when the gripper is in a use pose in which the support surface is oriented horizontally and facing upward, the first axis is also horizontal and the gripping surfaces are located above the support surfaces.

### CROSS-REFERENCE TO RELATED APPLICATIONS

The instant application claims priority to International Patent Application No. PCT/EP2021/071299, filed Jul. 29, 2021, which is incorporated herein in its entirety by reference.

### FIELD OF THE DISCLOSURE

The present disclosure relates to a robot gripper, to a robotic system comprising the robot gripper and to methods of using it.

### BACKGROUND OF THE INVENTION

Despite intensive development efforts, versatility and dexterity of current robot grippers falls far short of those of the human hand. Most two-finger grippers can hold an object only by squeezing it, so that if an object yields to the squeezing pressure, it is likely to escape from the gripper, or, if the gripper is controlled to maintain a certain squeezing pressure, be crushed by it. When a gripping surface isn't cushioned, it will exercise its squeezing force only onto a very limited surface region of the object, and is thus likely to damage it. Grippers with three curved fingers can seize an object without pressing it, but are ill-suited for handling objects of cuboid shape.

### BRIEF SUMMARY OF THE INVENTION

The present disclosure generally describes a robot gripper by which a large variety of differently shaped objects, yielding or unyielding, can be handled.

In one embodiment, the disclosure describes a modified two-finger gripper, i.e. a robot gripper comprising a palm and first and second fingers connected to said palm that have gripping surfaces facing each other for gripping an object between them and that are displaceable with respect to each other along a first axis normal to said gripping surfaces, the modification being in that the palm carries at least a third finger having a support surface, wherein, when the gripper is in a use pose in which the support surface is oriented horizontally and facing upward, the first axis is also horizontal, and the gripping surfaces are located above the support surfaces. Thus, since the third finger carries most of the weight of an object being handled, a very slight pressure exercised by the first and second fingers is sufficient for holding the object safely.

### BRIEF DESCRIPTION OF THE SEVERAL VIEWS OF THE DRAWING(S)

FIG. 1 is a perspective view of a gripper according to a first embodiment of the present disclosure.

FIG. 2 is a perspective view of a gripper according to a second embodiment of the present disclosure.

FIG. 3 is a schematic rear view of a shelf with objects on it and a gripper placed to seize one of them in accordance with the disclosure.

FIG. 4 is a schematic top view of the robotic system in accordance with the disclosure.

FIG. 5 illustrates part of a gripper according to a third embodiment of the present disclosure.

### DETAILED DESCRIPTION OF THE INVENTION

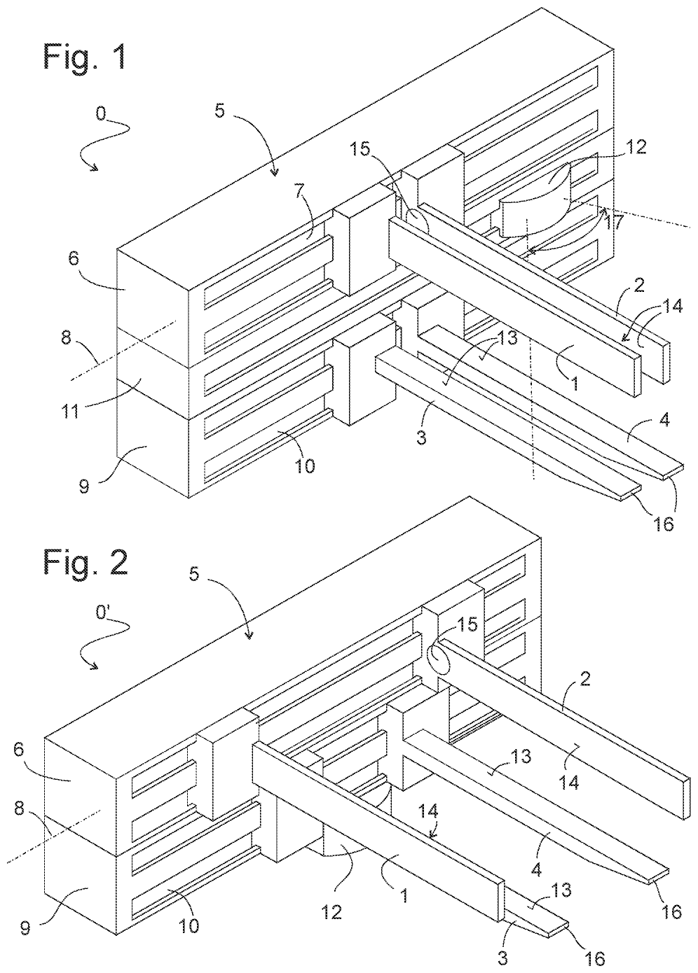

FIG. 1 is a perspective view of a gripper 0 having first to fourth fingers 1-4. In analogy to the human hand, a central portion of the gripper 0 to which the fingers 1-4 are movably connected is referred to as a palm 5. In the embodiment of FIG. 1, the palm 5 comprises a first rail unit 6 defining a rail 7 in which fingers 1 and 2 are displaceable along a first axis 8, a second rail unit 9 defining a rail 10 in which fingers 3 and 4 are displaceable in parallel to first axis 8, and a third rail unit 11 in which a 2D scanner 12 is displaceable in parallel to first axis 8. Each finger 1-4 and the 2D scanner 12 has a motor, not shown, and associated with it for driving displacement thereof. Each motor is operable independently of the others.

The fingers 1-4 are elongate in a direction perpendicular to the first axis 8. Fingers 3, 4 have support surfaces 13 that extend in a same plane which, in the pose of FIG. 1, is horizontal. Fingers 1, 2 have gripping surfaces 12 that face each other and extend in a plane perpendicular to axis 8. Each finger 1, 2 has a sensor 15 associated to it, for detecting a force or a torque applied to its gripping surface 12. FIGS. 1 and 2 suggest that the sensor 15 is provided on the fingers 1, 2, but in practice, the sensor may just as well be a measurement circuit connected to the motor of a finger and adapted to estimate force or torque based on characteristics of electric currents flowing in the motor.

Fingers 3 and 4 have pointed tips 16, in order to facilitate their introduction below an object to be seized by advancing in their longitudinal direction.

The 2D scanner 12 is shown in a position laterally offset with respect to the fingers 1-4. It is designed to detect objects in a plane 17 by emitting a laser beam in different directions in the plane, and detecting its reflection. The plane 17 is parallel to the plane of the support surfaces 13 and extends at a level between these and the fingers 1, 2. In operation the 2D scanner 12 is most likely to be placed in a central position between the fingers 1-4, in order enable precise detection of the shape of an object to be seized and in front of which the gripper 0 is placed.

In the embodiment of FIG. 1, a certain minimum distance is maintained in the vertical direction between the plane 17 and between the two pairs of fingers 1, 2 and 3, 4, in order to prevent the fingers 1-4 from interfering with the detection of objects by the 2D scanner 12. Therefore no objects can be seized by gripper 0 whose height is less than this minimum distance.

The gripper 0′ of FIG. 2 is capable of seizing smaller objects since the 2D scanner 12 is mounted below the rail unit 9 of fingers 3, 4, and therefore, no minimum distance must be maintained between the plane of the support surfaces 13 and the fingers 1, 2. In order to detect an object prior to seizing it, the gripper 0′ must be placed in front of the object at such a height that the sensing plane 17 intersects the object, and the support surfaces 13 are higher than a bottom side of the object. The fingers 3, 4 can therefore be inserted below the object only after the gripper 0′ has been lowered appropriately.

Another difference is that in the gripper 0′ the 2D scanner 12 has no rail unit associated to it but is immobile with respect to the palm 5, which reduces the cost of the gripper 0′. By displacing the entire gripper 0′ in the direction of axis 8, the 2D scanner 12 can still be placed directly in front of an object to be seized, unless displacement of the gripper 0 is prevented by some external obstacle.

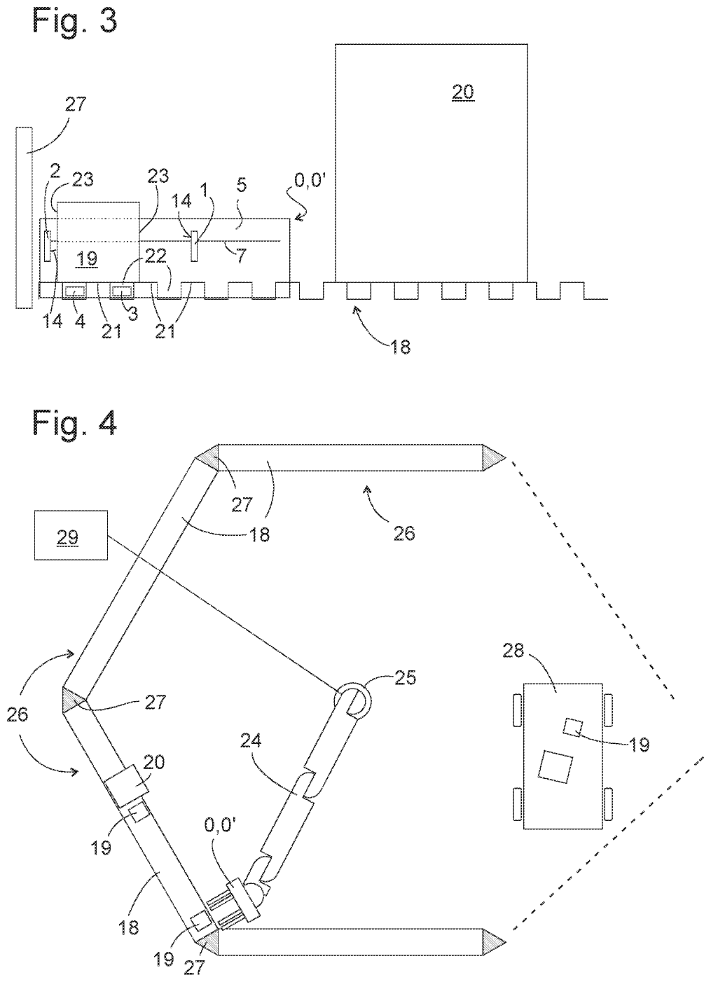

FIG. 3 is a schematic view of a shelf 18 carrying objects 19, 20 to be handled by the gripper 0 or 0′. The view is from a rear side of the shelf 18, opposite to the direction in which the gripper 0, 0′ approaches the shelf. An upper side of the shelf 18 is divided into a plurality of support strips 21 that extend in the direction of view and are separated by gaps 22 wide enough to accommodate the fingers 3, 4. The gaps 22 can be grooves in a corrugated profile, opening in the upward direction, as shown in FIG. 3. Else the gaps can be open in upward and downward directions, the strips 21 being individually mounted at a shelf unit rear wall. As a further alternative, the strips 21 can be upper edges of thin webs rising from a horizontal support plate, similar to webs of a conventional heat exchanger. In fact, the width of the support strips 21 can be much less than that of the gaps 22; the narrower the strips are, the easier it is to find a position for the fingers 3, 4 from where they can be inserted into the gaps 22.

In any case, the fingers 3, 4 can be inserted underneath an object 19 by introducing them into the gaps 22 in their longitudinal direction. Since contact between the support surfaces 13 of the fingers 3, 4 and the object 19 can be avoided during the introduction, there is no risk of the object 19 being pushed towards a rear side of the shelf 18 by the fingers 3, 4.

Detection of the position of the object 19 on the shelf 18 by 2D scanner 12 allows adjusting the positions of fingers 1, 2 so that when the fingers 3, 4 are inserted underneath object 19, fingers 1, 2 will pass by lateral flanks 23 of the object 19 at a safe distance, and will not displace the object 19, either.

Preferably, based on data from the 2D scanner, the fingers 1, 2 are adjusted symmetrically with respect to the flanks 23 of the object 19, so that, when the fingers 3, 4 are inserted in the gaps 22 and the fingers 1, 2 face the flanks 23, setting the fingers 1, 2 in motion towards the object 19 at the same time will cause their gripping surfaces 14 to make contact with both flanks 23 at the same time, and to build up pressure on the flanks 23 until the force or torque detected by sensor 15 exceeds a predetermined threshold.

Since contact occurs at both gripping surfaces at the same time, the force is substantially the same on both gripping surfaces 14, so that a single sensor 15 is sufficient for controlling the approach of fingers 1, 2.

When the fingers 1, 2 have been placed asymmetrically with respect to the lateral flanks 23, as shown in FIG. 3, and the fingers 1, 2 are displaced towards each other, finger 2, being closer to object 19 than finger 1, is the first finger to make contact. If there is only one force/torque sensor 15, the force threshold must be set higher than the friction between the object 19 and the shelf 18, so that finger 2 can push the object 19 sideways until finger 1 makes contact, too.

Alternatively, when each finger 1, 2 has a sensor associated to it, and when contact is detected by the sensor 15 of finger 2, displacement of finger 2 can be stopped, whereas finger 1 continues to move until it makes contact with object 19. In this way, gripping surfaces 14 can make contact with both sides of object 19 without pushing it sideways.

In either case pressure exerted on the object by the fingers 1, 2 can be maintained at a level low enough to prevent damage to the object 19.

In a next step the gripper 0, 0′ is raised, so that the fingers 3, 4 come into contact with an underside of object 19 and finally come to bear most of the weight of the object 19. The object 19 can now be carried to some other location and placed there.

As shown in FIG. 4, the gripper 0, 0′ can form the end effector of an articulate robot 24. When the robot 24 is mounted to a stationary base 25, shelf units 26 can be provided in an arcuate or polygonal arrangement centered on the base, so that all shelf units 26 are easily accessible to the gripper 0, 0′ by the robot 24 rotating around base 25. Each shelf unit 26 comprises a plurality of shelves 18 as shown in FIG. 3, held one above the other by posts 27. Seizing a small object 19 on one of these shelves may be difficult when a large object 20 next to it, possibly projecting beyond a front edge of the shelf 18, or a post 27 prevents the gripper from coming close to the front edge.

With the gripper 0, 0′ of the invention, this problem is avoided due to the possibility of controlling the displacement of all fingers 1-4 independently from the others. Therefore, the object 19 to be seized doesn't have to be centered in front of the gripper 0, 0′. Instead, the gripper can be asymmetrically disposed, as shown in FIG. 3: Here, the center of palm 5 is offset to the right with respect to object 19 to such an extent that it doesn't overlap with the post 27. Finger 2 has been placed at the left end of rail 7, facing a space between the left flank 23 of object 19 and the post 27. Finger 1 is placed to the right of the right flank 23. Therefore, the gripper 0 can advance towards object 19 as far as necessary to seize it without being blocked by post 27.

In practical operation, the robotic system of FIG. 4 can be used for e.g. gathering from the shelves 18 and placing on a trolley 28, a conveyor or some other means of transport objects 19 that have been ordered by a user. When an order for a specified object is received by a controller 29 of the robotic system, the controller 29 looks up an inventory of stored objects and retrieves from there an approximate position of the object and, possibly, handling information specifying e.g. the maximum force to which the object may be subjected. Based on the approximate position, controller 29 controls robot 24 to move the gripper 0 there. The approximate position must so accurate that when the gripper 0 has reached it, the 2D scanner 12 is close enough to detect and identify the object 19 and, if present, obstacles 20, 27 in its vicinity, so that based on data from the 2D scanner, the controller 29 can adjust the gripper 0 to the position of the object 19 by placing it in a position in front of the object 19 from where, by advancing the gripper 0 in the longitudinal direction of its fingers 1-4, the fingers can be placed at the flanks 23 and underneath the object 19. The robotic system is thus tolerant against minor irregularities of position of the objects that may occur when the objects are initially placed on the shelves 18 by hand or if an object is displaced by the gripper 0 while handling an adjacent one.

In this position of the gripper, if necessary, the position of fingers 3 and 4 along rail 10 is adjusted so that the tips of the fingers 3, 4 face gaps 22 between support strips 21 on which the object 19 rests.

The gripper 0 is then advanced so that the fingers 1-4 are placed at the flanks 23 and underneath object 19. Fingers 1, 2 are approached to each other as described above so that object 19 is nipped between their gripping surfaces 14. The force applied to the object 19 by the gripping surfaces 14 may be controlled based on information on the object 19 retrieved from the inventory. Object 19 is thus seized, raised and conveyed to trolley 28.

The trolley 28 can have a support surface formed of support strips, just like the shelves 18. In that case, the sensor 12 attached to the lower edge of the palm 5, as shown in FIG. 2, is appropriately placed for detecting gaps between the support strips, so that based on data from sensor 12, controller 29 can adjust the position and orientation of the fingers 3, 4 so that these, when descending the gripper, will smoothly enter the gaps and leave the object resting on the support strips.

Alternatively, when the object 19 has to be placed on a flat surface of trolley, fingers 3, 4 may first be moved away from each other, to positions beyond the gripping surfaces 14 of fingers 1, 2, and the gripper 0 then lowered until the underside of the object 19 or the fingers 3, 4 come into contact with a tabletop of trolley 28. By moving fingers 1, 2 away from each other, the object 19 is released.

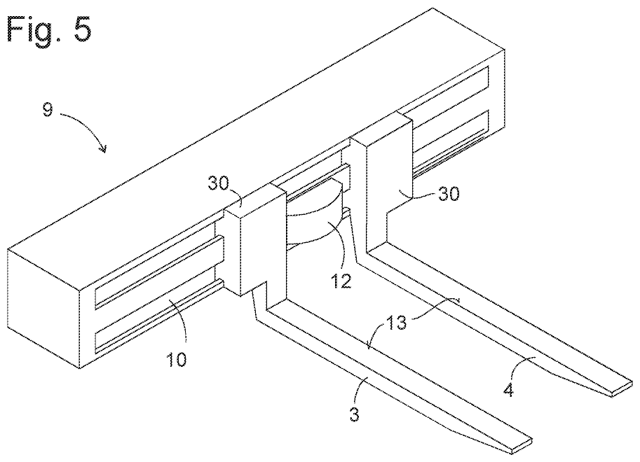

FIG. 5 illustrates the rail unit 9 and fingers 3, 4 guided by it according to a third embodiment. The fingers 1, 2 and their associated rail unit 6 are not shown since they are identical to those of FIGS. 1 and 2. The fingers 3, 4 are cranked, their support surfaces 13 being located below a bottom side of rail unit 9. By this arrangement the fingers 3, 4 can be lowered into gaps 22 between support strips 21 of a shelf 18 from above, even if the rail unit 9 itself is located above the shelf 18. The gripper of this embodiment can therefore handle objects on a shelf the depth of which is much greater than the length of the fingers 1-4, and it can successively handle objects placed on the shelf one behind the other.

The 2D scanner 12 is placed between base portions 30 of the fingers 3, 4, above the support surfaces 13. It can be connected to one of the base portions 30 so that when the two fingers 3, 4 have been adjusted to enter gaps 22 on either side of the center of gravity of an object 19 to be seized, the 2D scanner 12 is substantially aligned with the object 19.

A pointed distal end of the third finger can be helpful for introducing the third finger below the object to be handled. The third finger can be displaceable in parallel to the first axis, in order to adjust its position to the center of gravity of the object.

The third finger can be displaceable between different sides of a plane defined by the gripping surface of the first finger. By moving the third finger to a side of said plane which is remote from the second finger, the space between the gripping surfaces can be cleared, and the object can be placed on a support directly, without afterwards having to retract the third finger from underneath.

In order to allow the third finger to move independently from the first and second fingers, the palm may comprise a first rail defining the first axis for guiding displacement of the first and second fingers, and a second rail parallel to the first rail and defining a second axis for guiding displacement of the third finger.

A fourth finger may be provided that has a support surface coplanar with the support surface of the third finger and thus assists the third finger in carrying the weight of the object. By spacing the third and fourth fingers apart from each other, stability of support of the object can be improved.

Preferably, the fourth finger is displaceable in parallel to the first axis, too; it may be guided by the second rail mentioned above.

A force or torque sensor should be associated to at least one of the first and second fingers. Controlling displacement of the first and second fingers is facilitated if both have a sensor associated to them, as will be explained in detail below.

In order to facilitate placement of the robot gripper adjacent an object to be seized, the robot gripper may comprise a sensor which is arranged to monitor a space in front of the palm.

Preferably, the sensor is a 2D scanner. The 2D scanner can not only detect whether an object to be seized is present in front of the gripper, but it can also provide quantitative information on the position of the gripper with respect to the object which can be used for adapting the position of the gripper as a whole or, preferably of individual fingers of the gripper. When information from the 2D scanner is to be used for controlling positions of the fingers parallel to the first axis, the 2D scanner should have a detection plane parallel to the first axis or to the support surface.

For fast and efficient operation of the robot gripper, the detection plane should preferably be located between a plane defined by lower edges of the first and second fingers, on the one hand, and the support surface, on the other, so that when the gripper is placed at a height appropriate for introducing the third finger below an object to be seized, the object will extend through the detection plane. Thus, the positions of its first and second fingers can be adjusted to the positions of lateral flanks of the object based on data from the sensor, and when the adjustment is done, the gripper can be advanced to seize the object without any further correction of its position.

According to an alternative preferred embodiment, the sensor and its detection plane are located below the third finger. This design implies that for scanning an object before seizing it, the gripper must first be placed so that its detection plane intersects the object, and then lowered so as to enable introduction of the third finger below the object. The advantage of this embodiment lies in the fact that the 2D scanner isn't blocked by an object held in the gripper, and can therefore be used to inspect a target locating where the object is to be placed, before actually placing the object, which may help to avoid interference of the fingers with the detection of the object by the 2D scanner.

While for gripping and releasing an object it would be sufficient if the first and second fingers were coupled to be displaceable in opposite directions only, in the context of the present invention it is highly desirable that the first and second fingers should be displaceable along said first axis in a same direction or that one of the first and second fingers should be displaceable along the first axis while the other is standing still, as will be explained in more detail below.

In another aspect, the present disclosure describes a robotic system comprising a robot, in particular an articulated robot, equipped with the gripper as described above, and a shelf for storing objects to be handled by the gripper.

In such a system, seizing an object is facilitated by an upper side of the shelf comprising support strips for supporting the object, separated by gaps sized to accommodate the third, and, if present, the fourth finger. Thus, the third and fourth fingers can be inserted longitudinally underneath the object without pushing the object.

A shelving unit may comprise one or more shelves supported by posts. When the gripper is advancing into the shelving unit in the course of steps b) and d), in order to seize an object located close to a post, interference of the post with the gripper palm may prevent the gripper from advancing far enough. Similarly, a big object on the same shelf may hinder advancement of the gripper. According to the invention, this can be avoided by carrying out, prior to steps b) and d), the steps of,
f) identifying an obstacle adjacent to the object to be seized;
g) disposing the gripper in a position in which it does not overlap with the obstacle when seen in the advancing direction, and
h) adjusting the position of one of the first and second fingers to overlap with a space between the object and the obstacle.

The 2D scanner can facilitate seizing an object also in a robot gripper that doesn't have a third or fourth finger. Therefore, the invention also relates to a gripper comprising a palm and first and second fingers connected to said palm that have gripping surfaces facing each other for gripping an object between them and that are displaceable with respect to each other along a first axis normal to said gripping surfaces, wherein the palm further carries a 2D scanner, in particular a 2D scanner having a detection plane parallel to the first axis.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

0 gripper
1 finger
2 finger
3 finger
4 finger
5 palm
6 rail unit
7 rail
8 axis
9 rail unit
10 rail
11 rail unit
12 2D scanner
13 support surface
14 gripping surface
15 sensor
16 tip
17 plane
18 shelf
19 object
20 object
21 support strip
22 gap
23 flank
24 robot
25 base
26 shelf unit
27 post
28 trolley
29 controller
30 base portion

What is claimed is:

1. A robot gripper, comprising:
a palm;
first and second fingers connected to the palm, each of the first and second fingers having gripping surfaces facing each other for gripping an object between them, the first and second fingers being displaceable with respect to each other along a first axis that extends normal to the gripping surfaces; and
at least a third finger connected to the palm, the third finger having a support surface;
wherein, when the gripper is in a use pose in which the support surface is oriented horizontally and facing upward, the first axis is also horizontal and the gripping surfaces are located above the support surface.

2. The robot gripper of claim 1, wherein the third finger is displaceable in parallel to the first axis.

3. The robot gripper of claim 2, wherein the third finger is displaceable between different sides of a plane defined by the gripping surface of the first finger.

4. The robot gripper of claim 1, wherein the palm comprises a first rail defining the first axis for guiding displacement of the first and second fingers, and a second rail extending parallel to the first rail and defining a second axis for guiding displacement of the third finger.

5. The robot gripper of claim 1, further comprising a fourth finger, the fourth finger having a corresponding support surface that is coplanar with the support surface of the third finger.

6. The robot gripper of claim 1, further comprising a force or torque sensor associated with at least one of the first finger and the second finger.

7. The robot gripper of claim 1, further comprising a sensor is arranged to monitor a space in front of the palm.

8. The robot gripper of claim 7, wherein the sensor is a 2D scanner having a detection plane that extends parallel to the support surface.

9. The robot gripper of claim 7, wherein the sensor is disposed on the palm, below the third finger.

10. The robot gripper of claim 1, wherein the first and second fingers are displaceable along the first axis in a same direction.

11. The robot gripper of claim 1, wherein one of the first and second fingers is displaceable along the first axis while the other is standing still.

12. A robotic system comprising:
a robot,
a shelf; and
a gripper, wherein the gripper comprises:
a palm;
first and second fingers connected to the palm, each of the first and second fingers having gripping surfaces facing each other for gripping an object between them, the first and second fingers being displaceable with respect to each other along a first axis that extends normal to the gripping surfaces; and
at least a third finger connected to the palm, the third finger having a support surface;
wherein, when the gripper is in a use pose in which the support surface is oriented horizontally and facing upward, the first axis is also horizontal and the gripping surfaces are located above the support surface;
wherein the shelf is adapted to store objects to be handled by the gripper.

13. The robotic system of claim 12, wherein an upper side of the shelf comprises support strips for supporting the objects, the objects being separated by gaps, the gaps sized to accommodate the third finger.

14. A method of operating a robot gripper, comprising:
providing a gripper, the gripper including a palm, first and second fingers connected to the palm, each of the first and second fingers having gripping surfaces facing each other for gripping an object between them, the first and second fingers being displaceable with respect to each other along a first axis that extends normal to the gripping surfaces, and at least a third finger connected to the palm, the third finger having a support surface; wherein, when the gripper is in a use pose in which the support surface is oriented horizontally and facing upward, the first axis is also horizontal and the gripping surfaces are located above the support surface;
identifying an object to be seized, the object disposed on a support;
placing the first and second fingers on opposite flanks of the object;
approaching the first and second fingers until the object is in contact with the gripping surfaces of both fingers;
placing at least the third finger underneath the object; and
removing the object from the support.

15. The method of claim 13, wherein placing at least the third finger underneath the object is carried out by the third finger longitudinally engaging a gap of the support.

16. The method of claim 14, wherein placing the first and second fingers, and placing at least the third finger, are carried out by advancing the gripper in a longitudinal direction of the fingers.

17. The method of claim 14, further comprising:
identifying an obstacle adjacent to the object to be seized;
disposing the gripper in a position in which the gripper does not overlap with the obstacle when seen in an advancing direction; and
adjusting a position of one of the first and second fingers to overlap with a space between the object and the obstacle.
